(19) United States
(12) Patent Application Publication
(10) Pub. No.: US 2026/0164206 A1
(43) Pub. Date: Jun. 11, 2026

(54) HEADTRACKING ADJUSTED BINAURAL AUDIO

(71) Applicant: DOLBY LABORATORIES LICENSING CORPORATION, San Francisco, CA (US)

(72) Inventors: Yuxing HAO, Beijing (CN); Xuemei YU, Beijing (CN)

(73) Assignee: DOLBY LABORATORIES LICENSING CORPORATION, San Francisco, CA (US)

(21) Appl. No.: 18/698,762

(22) PCT Filed: Oct. 7, 2022
(86) PCT No.: PCT/US2022/045959

§ 371 Date: Apr. 4, 2024

Related U.S. Application Data
(60) Provisional application No. 63/279,243, filed on Nov. 15, 2021.
(60) Provisional application No. 63/324,357, filed on Mar. 28, 2022.

(30) Foreign Application Priority Data
Oct. 8, 2021 (WO) PCT/CN2021/122629
Mar. 25, 2022 (EP) 22164317.4

(51) Int. Cl. H04S 7/00

(52) U.S. Cl. CPC H04S 7/303; H04S 2420/01

(57) ABSTRACT

The present disclosure relates to a method and an audio processing system (1) for generating a pair of binaural audio signals (L_{B}, R_{B}). The method comprises obtaining (S1a) a pair of input audio signals (L, R) of an audio presentation, performing upmixing (S2) of the input audio signals (L, R) to generate three decorrelated audio signals (L_{D}, R_{D}, C_{D}), each decorrelated audio signal having a direction of incidence (41, 42, 43) on a listening position. The method further comprises, for each decorrelated audio signal, determining a pair of interaural difference values based on the direction of incidence of the decorrelated audio signals (L_{D}, R_{D}, C_{D}), a head-related transfer model and head rotation information. The method further comprises generating (S4) a binaural audio signal pair (L_{B}, R_{B}) based on the three decorrelated audio signals (L_{D}, R_{D}, C_{D}) and the interaural difference values.

### CROSS-REFERENCE TO RELATED APPLICATION

This application claims priority of the following priority applications: U.S. provisional application 63/324,357, filed 28 Mar. 2023, EP Application Serial No. 22164317.4, filed 25 Mar. 2022, U.S. provisional application 63/279,243, filed 15 Nov. 2021, and PCT/CN2021/122629, filed 8 Oct. 2021. The contents of all of the above applications are incorporated by reference in their entirety for all purposes.

### TECHNICAL FIELD OF THE INVENTION

The present disclosure relates to a method for generating a binaural audio signal with the sound image rotated in accordance with a head rotation angle.

### BACKGROUND OF THE INVENTION

Binaural audio signal can provide an audio effect which in a convincing manner makes the listener believe he or she is physically present in the audio scene in which the binaural audio signal was captured. Binaural audio signals can be generated by recording an audio signal pair with a so called dummy head model in which a microphone is placed at each ear position of the dummy head model. Alternatively, binaural audio signals are generated by performing audio processing on one or more arbitrary audio signals for synthesizing an audio signal pair in accordance with a head-related transfer function (HRTF) describing how the sound perceived by the left and right ear of a virtual listener will vary depending on the listeners position in the audio scene. Accordingly, binaural audio signals will, as accurately as possible, represent the sound field in the immediate vicinity of a virtual listener's eardrums and by listening to binaural audio signals, with e.g. earphones or loudspeakers with crosstalk cancellation, a user will be presented with a representation of the recorded audio scene nearly identical to the actual audio scene as perceived by the virtual listener or dummy head model used when recording the binaural audio signal.

Traditional binaural audio signals assume a stationary virtual listener or that the dummy head model used when recording the binaural audio signal is stationary. When a user listening to binaural audio signals also is stationary the binaural audio signals produce an acoustic effect which is capable of convincing the user of actually being present in the environment in which the binaural audio signal was recorded.

### GENERAL DISCLOSURE OF THE INVENTION

A drawback with the traditional binaural audio signals is that if the user moves while listening to binaural audio using earphones, e.g. if the user rotates his or her head to a new position, the immersion caused by the binaural effect is broken as the audio scene represented with the binaural audio signals will appear to move together with the user as opposed to the user moving relative to the audio scene. Further, if the user listens to binaural audio signals using a loudspeaker system with crosstalk cancellation the immersive effect is based on the user being still and facing a predetermined orientation meaning that as soon as the user moves, the binaural audio effect will be broken.

To this end, different solutions for adjusting the binaural audio signal by taking the head movements of the user into account have been proposed. However, in existing solutions, modification of the binaural audio signals by considering the head movements of the user is inaccurate and a computationally expensive procedure which is ill suited for implementation in audio devices with limited processing power, such as wireless earphones or earbuds. Additionally, recording or synthesizing binaural audio signals to obtain the enhanced level of immersion even for stationary use cases is already a cumbersome process in comparison to e.g. recording stereo audio.

To this end there is need for an improved method for generating a binaural audio signal with the sound image rotated in accordance with a head rotation angle.

A first aspect of the present invention relates to a method for generating a pair of binaural audio signals. The method comprises obtaining an audio presentation, the audio presentation comprising a pair of input audio signals and performing upmixing of the input audio signal pair to generate at least three decorrelated audio signals, each decorrelated audio signal having a direction of incidence on a listening position. The method further comprises obtaining a head-related transfer model positioned at the listening position, the head-related transfer model indicating a left ear position and a right ear position and obtaining head rotation information indicating the rotational orientation of a user's head with respect to the direction of incidence of the decorrelated audio signals. The method comprises determining, for each of said three decorrelated audio signals, a pair of interaural difference values based on the direction of incidence of the three decorrelated audio signals, the head-related transfer model and the head rotation information and generating a binaural audio signal pair based on the three decorrelated audio signals and the interaural difference values for each of said three decorrelated audio signals.

With a head-related transfer model it is meant a function describes the properties of an acoustic channel (e.g. the length or frequency response) to the left and right ear position respectively based on the direction of incidence of an audio signal and the head rotation information. A very simple example of a head-related transfer function is a function which determines, based on the direction of incidence of an audio signal and the head rotation information, which ear position faces away from the direction of incidence and sets the associated acoustic channel to zero (i.e. muted) and the other acoustic channel to unity (i.e. direct transfer). Accordingly, this simple head-related transfer function operates under the assumption that only audio originating from the left side of a head will be perceived by the left ear and no audio originating from the right side will be perceived by the left ear and vice versa for the right ear.

With head rotation information it is meant information indicating the orientation of a user's head. The rotation information may e.g. be a head rotation angle indicating how the user's head is rotation and e.g. which direction the user is facing.

An aspect of the invention is at least partially based on the understanding that by forming at least three decorrelated audio signals, each associated with a direction of incidence, and determining absolute interaural difference values for each decorrelated audio signal a more convincing virtualization effect is created which accounts for head rotation information. Decorrelated audio signals with an individual direction of incidence will enhance the spatial separation of the input audio signals and with two absolute difference values for each decorrelated audio signal the audio processing is more accurate which contributes to a more immersive virtualization effect.

The absolute difference values may be absolute interaural time difference values, absolute interaural distance difference values (which is linked to the time difference values via the speed of sound c) and absolute interaural level difference values.

In some implementations the head rotation information is obtained from head rotation determination means. The head rotation determination means may be any means suitable for determining the head rotation of a user around at least one axis of rotation. For instance, the head rotation determination means may comprise at least one of a gyro, a magnetometer, an accelerometer and an image sensor for capturing an image of the user or the surroundings of a user which in turn is used to determine the orientation of the user (using e.g. image processing).

The binaural audio signal pair may be rendered to an audio device such as a set of earphones or headphones or a set of loudspeakers with crosstalk cancellation configured to enable a user to listen to binaural audio signals without needing headphones or earphones. In implementations where loudspeakers with crosstalk cancellation is used to render the binaural audio output signals, the head rotation information is provided to the loudspeaker rendering system which adjusts the crosstalk cancellation matrix accordingly.

In some implementations, the head-related transfer model comprises a head model shape with a center position and the method further comprises determining, for each decorrelated audio signal an ipsilateral distance and a contralateral distance. The ipsilateral and contralateral distance being based on the shortest distance between an impact point and a respective ipsilateral and contralateral plane wherein the ipsilateral plane is normal to the direction of incidence of the decorrelated audio signal and intersects the ipsilateral ear position and the contralateral plane is normal to the direction of incidence of the decorrelated audio signal and intersects the center position. The impact point is defined as the point first reached by a plane wave travelling against the head model shape along the direction of incidence and the contralateral distance is further based on a distance along the head shape and between the contralateral plane and the contralateral ear position. Wherein the pair of interaural difference values is based on the ipsilateral distance and the contralateral distance.

The center position may be the listening position and the head-related transfer model shape may be any three-dimensional or two dimensional shape such as a sphere, an ellipsoid, a spheroid, a circle or an ellipse.

Accordingly, two absolute interaural difference values (related to time, distance and/or sound level) may be determined for each decorrelated audio signal which enables accurate virtualization for any head rotation information and incidence direction.

In some implementations, the three decorrelated audio signals comprises a decorrelated left audio signal, a decorrelated right audio signal, and a decorrelated center audio signal.

Accordingly, the input audio signal pair has been upmixed to a decorrelated left, right and center audio presentation such as a 3.0 audio presentation. For instance, a left incidence direction is associated with the left audio signal, a right incidence direction is associated with the right audio signal, and a center incidence direction is associated with the center audio signal wherein the angle between left and center incidence direction is equal to a separation angle and wherein the angle of intersection between the right and center incidence direction is equal to the same separation angle.

With such a symmetrical left, right and center decorrelated audio signal the interaural difference values may be determined in a simple way, by merely selecting one out of two functions describing the audio channel based on an include angle which is proportional to the head rotation angle.

According to a second aspect of the invention there is provided an audio processing system configured to carry out the method of the first aspect.

According to a third aspect of the invention there is provided a computer program product comprising instructions which, when the program is executed by a computer, cause the computer to carry out the steps of the method of the first aspect of the invention.

Any functions described in relation to a method may have corresponding features in a system or device and vice versa.

### BRIEF DESCRIPTION OF THE DRAWINGS

Implementations of the invention will be described in more detail with reference to the appended drawings, showing currently preferred embodiments of the invention.

FIG. 1 is a block diagram illustrating an audio processing system for generating a binaural audio signal according to some implementations.

FIG. 2 is a flowchart illustrating a method for generating a binaural audio signal according to some implementations.

FIG. 3a illustrates a head-related transfer model in a virtual acoustic scene with three decorrelated audio signals forming a symmetric left, right and center presentation according to some implementations.

FIG. 3b illustrates the interaural distance difference between a left and right ear of a head-related transfer model for an audio signal incident from the right according to some implementations.

FIG. 3c illustrates a head-related transfer model in a virtual acoustic scene with three decorrelated audio signals forming a symmetric left, right and center presentation, wherein the head-related transfer model has been rotated with the head rotation angle according to some implementations.

FIG. 4 illustrates in detail the interaural distance difference for a head-related transfer model with a spherical model shape according to some implementations.

FIG. 5 illustrates in detail the interaural distance difference for a head-related transfer model with a spherical model shape wherein the incidence of one decorrelated audio signal has been flipped around a center axis according to some implementations.

FIG. 6 is a block diagram illustrating the filter processing performed by the virtualizer unit according to some implementations.

FIG. 7a is a block diagram illustrating an audio processing system with reverberation processing for generating a binaural audio signal according to some implementations.

FIG. 7b is a block diagram illustrating an audio processing system with alternative reverberation processing for generating a binaural audio signal according to some implementations.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

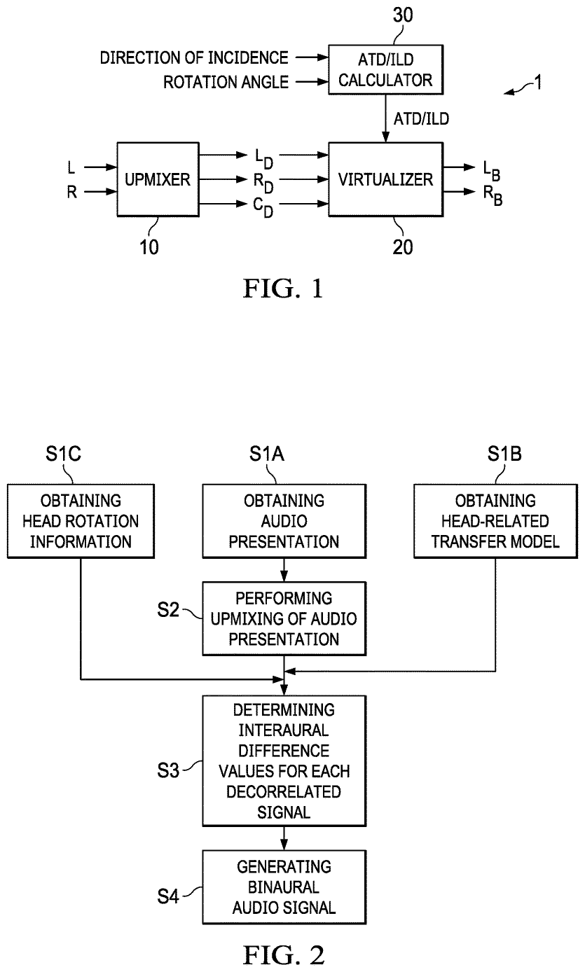

FIG. 1 depicts a block diagram of an audio processing system 1 for generating headtracking adjusted binaural audio and FIG. 2 is a flowchart illustrating a method performed by the audio processing system 1.

The audio processing system 1 comprises an upmixer unit which obtains a first number N of input audio signals, performs upmixing, and outputs a second number M of output audio signals, wherein the output audio signals are decorrelated and the second number M is greater than the first number N. In the depicted embodiment, the upmixing unit 10 obtains a left and right audio signal L, R of an audio presentation at step S1a and performs at step S2 two-to-three channel upmixing to create a decorrelated left audio signal L_{D}, a decorrelated right audio signal R_{D} and a decorrelated center audio signal C_{D}. The audio presentation comprising the input audio signals L, R may be a conventional stereo audio presentation or a binaural audio presentation.

The upmixing unit 10 may perform active matrix decoding of the input audio signals to obtain the output audio signals. The upmixing unit 10 may employ a multi-band algorithm to separate the first number N of input audio signals into the second number M of output audio signals. For instance, the multi-band algorithm may involve dividing the input audio signals into a plurality of sub-bands and combining the sub-band representations into the output audio signals.

One example of active matrix decoding which may be performed by the upmixing unit 10 is described in WO2010/083137. While many alternative implementations of active matrix decoding is possible one implementation utilizes three power ratio and gain control values (gL, gR and gF) as opposed to six power ratio and gain control values from the active matrix decoding in WO2010/083137 to extract the decorrelated center audio signal C_{D}. For instance, the decorrelated center audio signal C_{D} is obtained as a weighted sum of the left and right input signal L, R which is expressed as C_{D}=c₁L+c₂R where c₁ and c₂ are weighting coefficients. Accordingly, the decorrelated left and right audio signal L_{D}, R_{D} may then be obtained by subtracting the left and right input audio signal L, R from the decorrelated center audio signal C_{D} such that L_{D} is proportional to C_{D}-R and R_{D} is proportional to C_{D}-L.

Another alternative method of computing the decorrelated center audio signal C_{D} is to calculate a correlation between the left and right input audio signal L, R for each time segment. Based on the correlation of each time segment the left and right audio signals L, R are multiplied by a weighting factor and added together to form the decorrelated center audio signal C_{D}. Preferably, the left and right input audio signals L, R are first normalized prior to determination of the correlation and the correlation may be mapped to the weighting factor which ranges from 0 to 0.5. For instance, the weighting coefficients c₁ and c₂ may be equal to the weighting factor and thereby adjusted dynamically with time as the correlation between the left and right input audio signal L, R changes.

The audio processing system 1 further comprises an Absolute Time Difference (ATD) and/or Interaural Level Difference (ILD) calculator unit 30 configured to obtain direction of incidence information and head rotation information at step S1c.

The direction of incidence information obtained at S1c is indicative of the direction of incidence of each of the three decorrelated audio signals L_{D}, R_{D}, C_{D} on a listening position. The direction of incidence of each decorrelated audio signal L_{D}, R_{D}, C_{D} may change over time and/or the direction of direction of incidence of the decorrelated audio signals L_{D}, R_{D}, C_{D} may be changed between two or more predetermined incidence direction sets. For instance, the direction of incidence may indicate that a first decorrelated audio signal C_{D} is a first direction and the direction of incidence of the second and third decorrelated audio signals L_{D}, R_{D} is a left and right incidence direction placed on either side of the first direction of incidence so as to form an equal (stereo) separation angle θ with the direction of the decorrelated first audio signal C_{D}, wherein |θ| is between 0 and x radians or 0 and 180 degrees.

In some implementations, the direction of incidence of each decorrelated audio signal comprises an angle (defining the direction of incidence on the listening position in a horizontal plane) or the direction of incidence of each decorrelated audio signal comprises two angles (defining e.g. the azimuth and elevation angle of the direction of incidence on the listening position in spherical coordinates).

In some implementations, the direction of incidence information is predetermined and e.g. stored in a data storage unit of the ATD/ILD calculator. Alternatively, the direction of incidence information is updated continuously or e.g. set by a user. For instance, the direction of incidence information may comprise two or more alternative direction of incidence sets, each set indicating the direction of incidence for each of the at least three decorrelated audio signals. Accordingly, the direction of incidence may be swapped from one set (e.g. indicating a separation angle of θ=30 degrees) to another set of incidence directions (e.g. indicating a separation angle of θ=90 degrees).

The head rotation information is at least indicative of a rotation angle of the head of a user listening to binaural audio L_{B}, R_{B} which is outputted by the audio processing system 1. The head rotation angle may for example be obtained from a head tracker unit (e.g. provided in a set of headphones or earphones the user is wearing and using to listen to the binaural audio of the audio processing system 1) and indicative of a head rotation angle with respect to the direction of incidence of the of the decorrelated audio signals L_{D}, R_{D}, C_{D}. It is understood that while the directions of incidence are present in a virtual acoustic scene and the head rotation information is measured in a physical space there exists many suitable ways of mapping a rotation in the physical space to the virtual acoustic scene. For example, one predetermined direction in the physical space may be mapped to a reference direction in the virtual acoustic scene.

Furthermore, the ATD/ILD calculator unit 30 obtains at S1b a head related transfer model and uses the head rotation angle, the direction of incidence of the three decorrelated audio signals L_{D}, R_{D}, C_{D} and the head related transfer model to calculate at least two interaural difference values for each decorrelated audio signal L_{D}, R_{D}, C_{D}. In the implementation shown in FIG. 1, the ATD/ILD calculator unit 30 calculates at least six interaural difference values, i.e. at least two values for each decorrelated audio signal L_{D}, R_{D}, C_{D}. The interaural difference values may be at least one of interaural absolute time/distance difference values, indicating the absolute time/distance difference for audio signals reaching a left and right ear position of the head related transfer model, and interaural level difference values, indicating the level difference between audio signals reaching the left and right ear position of the head related transfer model.

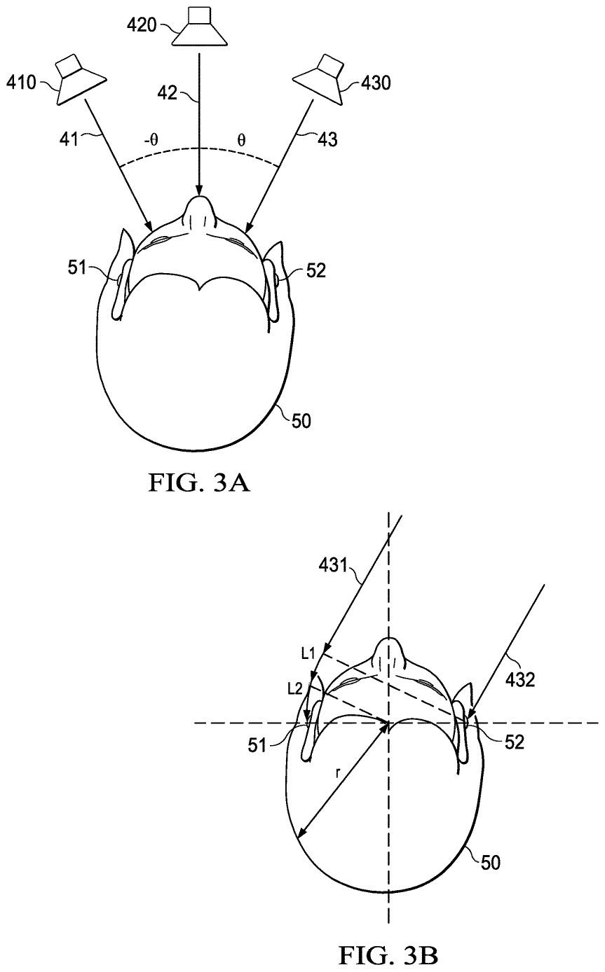

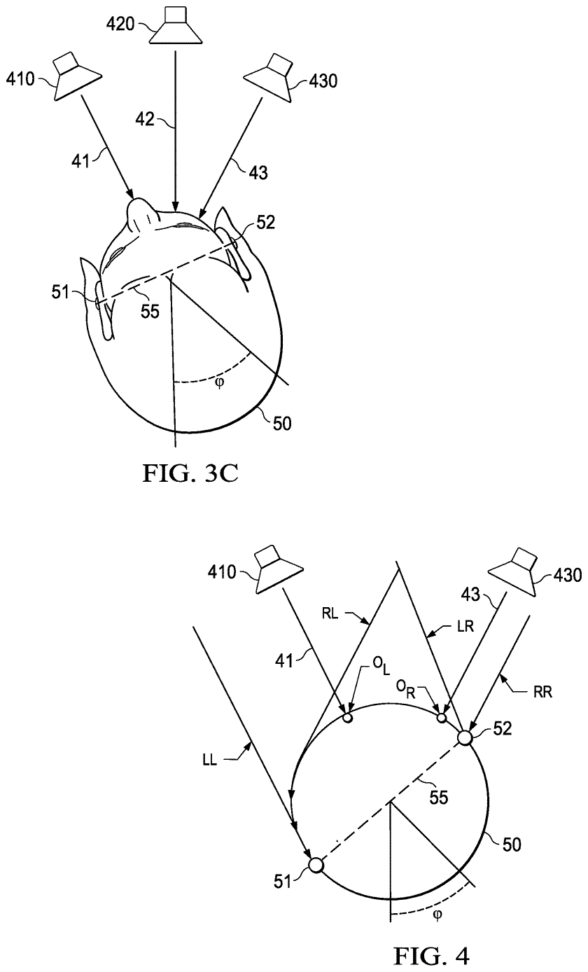

The calculation of the interaural difference values using the head-related transfer model will be described in detail in the below, in relation to FIGS. 3a, 3b, 3c, 4 and 5. Additionally, it is noted that the head-related transfer model may be stored in the ATD/ILD calculator unit 30 and that the head-related transfer model as such may be represented as a set of equations describing an (in general frequency variant) model of an acoustic channel from a direction of incidence with two ear positions respectively as a function of the incidence direction, the head rotation information and the respective ear position.

Additionally, it is understood that the audio processing system 1 has different working modes. For instance, the direction of incidence may be changed between different working modes which enables audio processing system to simulate different acoustic scenes. Moreover, the audio processing system 1 may obtain a conventional stereo input audio signal as an input and output a binaural audio signal which is based on the head rotation angle in a first working mode and obtain a binaural audio signal as an input and output an enhanced binaural audio signal which is further based on the head rotation angle in a second working mode.

While processing stereo input audio signals incidence directions may be adjusted to fit where the virtual loudspeakers are desired. For example, to simulate a virtual horizontally placed smartphone, the separation angle for a decorrelated left, right and center audio signals could be set to θ=30 degrees and if widely distributed audio objects are to be simulated the separation angle could be set to θ=90 degrees to make the sound field wider. Similarly, while processing binaural content, the separation angle should be adjusted to fit the user case. For example, to realize a movie theater similar sound effect, the separation angle could be set to θ=45 degrees and to realize a headphone similar experience, the separation angle could be set to θ=90 degrees.

It is noted that step S1a occurs prior to step S2, however, the order in which steps S1a/S2 are carried out with respect to step S1b and S1c is arbitrary. For instance, step S1c may be carried out before steps S1a and S1b wherein steps S1a and S1b are carried out substantially simultaneously.

At step S3 the decorrelated audio signals L_{D}, R_{D}, C_{D} of the upmixer unit 10 are provided to a virtualizer unit 20 alongside the interaural difference values from the ATD/ILD calculator unit 30. Then, at step S4, the virtualizer unit 30 performs audio processing of the decorrelated audio signals L_{D}, R_{D}, C_{D} to combine the decorrelated audio signals L_{D}, R_{D}, C_{D} into a left and right output audio signal L_{B}, R_{B} which forms a binaural audio presentation. The audio processing performed by the virtualizer unit 30 is based on the interaural difference values from the ATD/ILD calculator unit 30 and will be described in detail in relation to FIG. 6 in the below. In one implementation, the virtualizer unit 30 processes each of the decorrelated audio signals L_{D}, R_{D}, C_{D} with a respective left ear filter, wherein each left ear filter is based on one of the at least two interaural difference values of each decorrelated audio signal, to obtain three left ear filtered audio signals and processes each of the decorrelated audio signals L_{D}, R_{D}, C_{D} with a respective right ear filter, wherein each right ear filter is based on another one of the at least two interaural difference values of each decorrelated audio signal, to obtain three right ear filtered audio signals. Whereby the three left ear filtered audio signals are combined to form the left output audio signal L_{B} and the three right ear filtered audio signals are combined to form the right output audio signal R_{B}.

While the audio processing system 1 depicted in FIG. 1 comprises an upmixer unit 10, virtualizer unit 20, and ATD/ILD calculator unit 30 configured to operate with two input audio signals L, R and three decorrelated audio signals L_{D}, R_{D}, C_{D}, it is envisaged that the audio processing system 1 may be adapted to operate with more than two input audio signals and more than three decorrelated audio signals. In particular, it is noted that three input audio signals of a three channel audio presentation may be divided into seven decorrelated audio signals and, in general, that N number of input channels may be divided into 2^{N}-1 decorrelated audio signals.

Turning to FIG. 3a a virtual acoustic scene is depicted with the head-related transfer model 50 placed at the listening position and oriented with respect to the direction of incidence 41, 42, 43 of the decorrelated audio signals L_{D}, R_{D}, C_{D}. In FIG. 3a, FIG. 3b and FIG. 3c the decorrelated audio signals are depicted as virtual loudspeakers 410, 420, 430 and in some implementations the acoustic scene models the situation when the virtual loudspeakers 410, 420, 430 are infinitely distant from the head related transfer model 50 such that when the decorrelated audio signals L_{D}, R_{D}, C_{D} reaches the listening position the do so in the form of plane waves.

In some implementations, the decorrelated audio signals are decorrelated left, right and center audio signals wherein the decorrelated left audio signal (from virtual loudspeaker 410) and the decorrelated right audio signal (from virtual loudspeaker 430) are incident on the listening position of the head related transfer model 50 so as to form a separation angle of θ on either side of the incidence direction 42 of the center decorrelated audio signal. As seen, the separation angle θ is defined to be positive for the right incidence direction 43, zero for the center incidence direction 42 and −θ for the left incidence direction 41 although it is understood that other definitions of θ may be used analogously.

From FIG. 3a it is evident that the decorrelated right audio signal with direction of incidence 43 will have to travel a longer distance to reach the left ear position 51 of the head-related transfer model 50 than to reach the right ear position 52 and vice versa for the decorrelated left audio signal with direction of incidence 41.

With further reference to FIG. 3b the difference in distance the decorrelated right audio signal must travel from the right virtual speaker 430 to the left ear position 51 is illustrated under the assumption that the head-model shape of the head-related transfer model 50 is spherical. The interaural distance difference is the difference between the two illustrated paths 431 and 432 and the interaural distance difference comprises two portions, L1 and L2, wherein L1=r sin θ and L2=rθ wherein r denotes the radius of the head-related transfer model 50. Accordingly, the relative interaural time difference, ILD, can be calculated as

$$ILD = \frac{r}{c} ( θ + sin θ ) \qquad ( 1 )$$

where c is the speed of sound. Based on equation 1 simple linear filters may be created which provide relative time delays to the decorrelated audio signals and for the decorrelated left and decorrelated right audio signal. There will be four propagation paths: left loudspeaker 410 to left ear position 51 (ipsilateral), left loudspeaker 410 to right ear position 52 (contralateral), right loudspeaker 430 to left ear position 51 (contralateral) and right loudspeaker 430 to right ear 52 (ipsilateral). Based on this model there is defined two ILD values which may be used to generate a binaural audio presentation.

However, turning to FIG. 3c which illustrates the situation when the head-related transfer model 50 is rotated with a head rotation angle φ, it is evident that the two ILD values are not sufficient to represent the time difference in a general case when the user has turned his or her head as the speakers 410, 420, 430 will no longer be symmetrical about the head model normal line 55.

To this end, four absolute time/distance difference values are calculated instead of the relative interaural time difference values for the left and right decorrelated audio signals originating from the virtual loudspeakers 410, 430.

With reference to FIG. 4 the distances used to calculate the absolute time/distance difference values for the left decorrelated audio signal (originating from virtual loudspeaker 410) are shown as the distances differences between a path parallel with the incidence direction 41 and impacting the impact point OL and the path of left and right end LL, LR of the left plane wave respectively. Similarly, the distances used to calculate the absolute time/distance difference values for the right decorrelated audio signal (originating from virtual loudspeaker 430) are shown as the distance differences between a path parallel with the incidence direction 43 and impacting the impact point OR and the path of left and right end RL, RR of the right plane wave respectively.

The impact points OL, OR are defined as the point along the shape of the head-related transfer model 50 which is first impacted by a plane wave traveling towards the model 50 along the respective direction of incidence. Accordingly, the left decorrelated audio signal reaches its impact point OL after travelling along the left direction of incidence 41 whereby the left decorrelated will audio signal will travel an extra distance in free-space to reach the right ear position 52 (giving rise to a first absolute time difference) and an extra distance first in free space and then along the model shape to the left ear position 51 (giving rise to a second absolute time difference).

In other words, the absolute time differences for the left decorrelated audio signal with incidence direction 41 is associated with the part of path LL and LR that extends from a normal plane of the incidence direction, which intersects the left impact point O_{L}, and the left and right ear position 51, 52 respectively. The absolute time differences for the right decorrelated audio signal with incidence direction 43 is associated with the part of path RL and RR that extends from a normal plane of the incidence direction, which intersects the right impact point O_{R}, and the left and right ear position 51, 52 respectively. In a similar fashion the absolute time differences may also be calculated for a center decorrelated audio signal, or any audio signal with an arbitrary direction of incidence.

It is understood that the properties of the head-related transfer model 50 in FIG. 4 may be altered while still allowing the method for calculating the absolute time/distance described in herein to be implemented analogously. For instance, the shape of the head-related transfer model may as shown be circular with the ear positions 51, 52 being located on opposite points of the circular shape. Moreover, the ear positions 51, 52 may be placed arbitrarily and e.g. not symmetrically on the circular shape and it is also noted that the shape of the head related transfer model 50 may be another shape than a circular (spherical) shape, e.g. elliptical or shaped to mimic the shape of an actual head as shown in FIGS. 3a, 3b, and 3c.

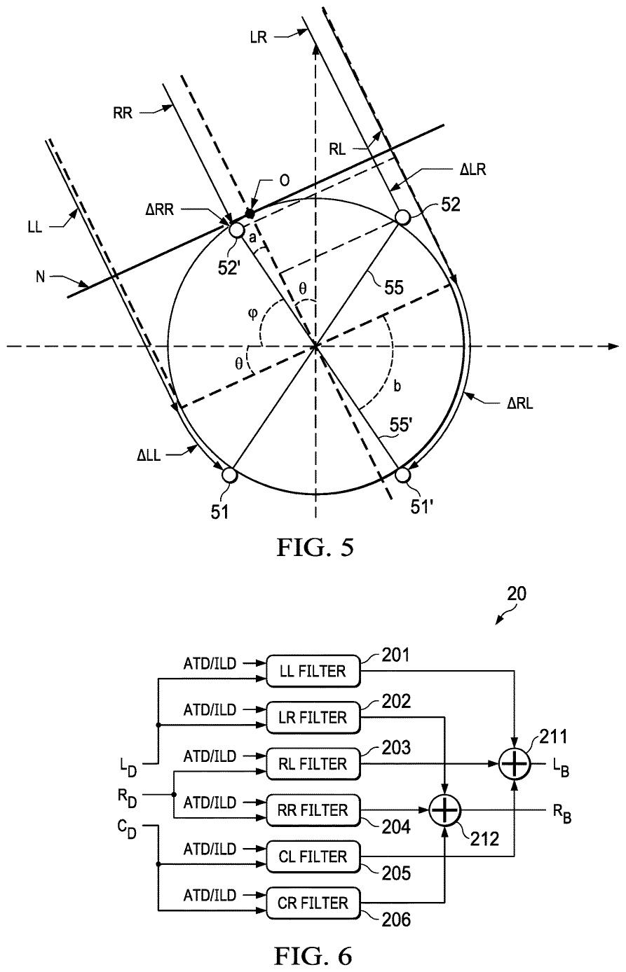

FIG. 5 depicts a head-related transfer function 50 with a circular shape. If the direction of incidence 43, the paths RL, RR and the head normal line 55 in FIG. 4 are flipped around a vertical center axis the impact points O_{L}, O_{R} will overlap at a single impact point O as seen in FIG. 5. In FIG. 5 the flipped head normal line 55′ is shown together with the flipped positions of the left and right ear positions 51′, 52′. The flipped representation of FIG. 5 highlights the differences in distances the decorrelated left and right audio signal travels to reach each ear position 51, 52, 51′, 52′. It is determined that the additional distance travelled by the decorrelated audio signals from the normal plane N to the respective ear position gives rise to the following absolute time difference values from the impact point O:

$$Δ LL = A = \frac{r}{c} ( 1 - cos ( \frac{π}{2} - φ - θ ) ) = \frac{r}{c} ( 1 - sin ( φ + θ ) ) \qquad ( 2 )$$

$$Δ RR = B = \frac{r}{c} ( 1 - cos ( \frac{π}{2} - φ + θ ) ) = \frac{r}{c} ( 1 - sin ( φ - θ ) ) \qquad ( 3 )$$

$$Δ RL = {A}^{′} = \frac{r}{c} ( 1 + φ + θ ) \qquad ( 4 )$$

$$Δ LR = {B}^{′} = \frac{r}{c} ( 1 + φ - θ ) \qquad ( 5 )$$

which depends on the separation angle θ and the head rotation angle φ. In equations 2 through 5 ΔLR denotes a function A indicating the absolute time/distance difference for the left decorrelated audio signal to reach the right ear position 52 (an ipsilateral distance), ΔLL denotes a function B indicating the absolute time/distance difference for the left decorrelated audio signal to reach the left ear position 51 (a contralateral distance), ΔRR denotes denotes a function A′ indicating the absolute time/distance difference for the right decorrelated audio signal to reach the right ear position 52′ (an ipsilateral distance) and ΔRL denotes a function B′ indicating the absolute time/distance difference for the right decorrelated audio signal to reach the left ear position 51′ (a contralateral distance). In FIG. 5 the distances LL, RR, RL and LR extend to the normal plane N while the difference distances, ΔLL, ΔRR, ΔRL and ΔLR extend from the normal plane N to their respective ear position 51, 52. Moreover, while equations 2 through 5 are for the absolute time difference, the distance difference is calculated analogously, merely with the coefficient r/c replaced with r.

Moreover, it is noted that setting φ=0 in equation 2 through 5 yields

$$\vert {A}^{′} - A \vert = \frac{r}{c} ( θ + sin ( θ ) ) \qquad ( 6 )$$

$$\vert {B}^{′} - B \vert = \frac{r}{c} ( θ + sin ( θ ) ) \qquad ( 7 )$$

which is equivalent to the simple relative interaural time difference (ITD) described in equation 1 in the above. Additionally, it is understood that equations 2 through 5 may be used to determine the time/distance difference for an audio signal with an arbitrary direction of incidence from the corresponding impact point to each respective ear position 51, 52. For instance, setting θ=0 in equations 2 through 5 yields two equations which may be used to determine the extra distance traveled from the impact point of a center decorrelated audio signal to each ear position 51, 52 based on the separation angle θ and the head rotation angle φ.

It is envisaged that while the shape of the head-related transfer model in FIG. 5 is depicted as substantially spherical (and circular in its cross-section) other shapes which more accurately represents the head of a human may be used instead. For instance, the shape may be an ellipsoid or spheroid giving rise to an elliptic cross-sectional shape. Additionally, the ear positions 51, 52 may placed symmetrically or asymmetrically on the shape of the head-related transfer model 50 (i.e. at positions other than the opposite positions depicted in FIG. 5).

For different values of the head rotation angle φ the selection of function A, B, A′, B′ changes to properly describe the absolute time difference between the left and right virtual speaker 410, 430 and the left and right ear position 51, 52. Table I below illustrates how functions A, B, A′, B′ are used as a function of φ.

TABLE I

| | Left speaker | Left speaker to | Right speaker | Right speaker to |
|---|---|---|---|---|
| | to left ear | right ear | to left ear | right ear |
| φ (radians) | position | position | position | position |
| 0 ≤ φ < π/2 | B′ | B | A′ | A |
| π/2 ≤ φ < π | A′ | A | B′ | B |
| −π ≤ φ < −π/2 | B | B′ | A | A′ |
| −π/2 ≤ φ < 0 | A | A′ | B | B′ |

It is understood that the distance difference traveled by a decorrelated audio signal from the normal plane N to a respective ear position 51, 52, 51′, 52′ is linked to an absolute time difference via the speed of sound, c and vice versa.

While referring to table I each time the time/distance/level difference should be updated, which e.g. is each time φ changes (which could be tens or even hundreds of times per second) is in principle a simple process it may be simplified for more efficient implementation. For instance, an ear angle, e, is defined for each ear position 51, 52 wherein

$$ϵ = \{ \begin{matrix}φ - σ & , & for left ear position \\ φ + σ & , & for right ear position\end{matrix} \qquad ( 8 )$$

and wherein ϵ is normalized to (−π, π] and σ is constant selected between 0 and π (0 and 180 degrees) to describe the position of the left and right ear position 51, 52 on the head shape model. For instance, if σ is selected to be different from

$$\frac{π}{2}$$

$$e . g . 0 < σ < \frac{π}{2} ,$$

the ear positions 51, 52 will be asymmetrical which may mitigate front-back confusion. However, selecting

$$σ = \frac{π}{2}$$

means that the ear positions 51, 52 of the head shape model are symmetrical which is suitable in some implementations. For example, if

$$σ = \frac{π}{2}$$

and the head rotation angle is given by

$$φ = \frac{3 π}{4} ,$$

the ear angle in equation 8 is given by

$$ϵ = - \frac{3 π}{4}$$

for the left ear positions 51 and

$$ϵ = \frac{π}{4}$$

for the right ear position 52.

Based on the ear angle ϵ, an include angle α is defined to describe the relationship between each ear position 51, 52 and incidence direction respectively. The include angle α may be defined as

$$α = ϵ - θ \qquad ( 9 )$$

where θ is recognized as the speaker separation angle where positive angles, i.e. θ>0, is for directions of incidence from the right of the center direction of incidence and negative angles, i.e. θ<0, is for direction of incidence from the left of the center direction of incidence.

As an illustrative example, a situation is considered when the head rotation angle φ=45°, the direction of incidence is θ=−10° and

$$σ = \frac{π}{2}$$

which means (considering equation 8) that the ear angle, ϵ, is ϵ=−45° for the left ear position 51 and ϵ=135° for the right ear position 52. Consequently, turning to equation 9, the include angle, α, will be α=−45°+10°=−35° for the left ear position 51 and α=135°+10°=145° for the right ear position 52.

Based on the include angle α the absolute time/distance difference may be calculated using one of two equations based on the absolute value of the include angle |α|, wherein the absolute time difference, for instance, is calculated as

$$ATD = \{ \begin{matrix}\frac{r}{c} ( 1 - cos ( \vert α \vert ) ) , \vert α \vert \leq \frac{π}{2} \\ \frac{r}{c} ( 1 - \vert α \vert - \frac{π}{2} ) , \vert α \vert > \frac{π}{2}\end{matrix} \qquad ( 10 )$$

and wherein the interaural distance difference is calculated analogously, with the coefficient r/c replaced with r.

Additionally, while equation 10 describes the absolute time difference or absolute distance difference as a function of the head rotation angle it does not consider which ear position 51, 52 that is facing the direction of incidence (i.e. the ipsilateral ear position) and which ear position 51, 52 that is facing away from the direction of incidence (i.e. the contralateral ear position). To this end, a second include angle, β, is defined as

$$β = ( φ - θ - σ ) \qquad ( 11 )$$

wherein also second include angle β is normalized to (−π, π]. Based on the second include angle β and the direction of incidence of a decorrelated audio signal table II in the below may be referenced to determine which ear position 51, 52 is the ipsilateral ear (the other ear position 51, 52 being the contralateral ear).

TABLE II

| Ipsilateral ear | β < 0 | β ≥ 0 |
|---|---|---|
| θ < 0 | Right ear position | Left ear position |
| θ ≥ 0 | Left ear position | Right ear position |

Accordingly, by calculating the include angle α and/or the second include angle β the absolute time/distance difference and/or ipsilateral/contralateral ear mapping may be determined efficiently. By considering the absolute time/distance difference and/or ipsilateral/contralateral ear mapping the decorrelated audio signals a virtualizing effect may be generated with a virtualizer unit to form a binaural audio signal.

FIG. 6 illustrates the details of one implementation of the virtualizer unit 20 from FIG. 1. As seen, the decorrelated left audio signal L_{D} is provided to a Left-to-left (LL) filter 201 and to a Left-to-right (LR) filter 202 wherein each filter is based on at least one of absolute time/distance difference and the interaural level difference of the left decorrelated audio signal LD. The output of the LL filter 201 will then be the contribution of the decorrelated left audio signal L_{D} to the left output signal L_{B} and the output of the LR filter 202 will be the contribution of the decorrelated left audio signal L_{D} to the right output signal R_{B}. Similarly, the decorrelated right audio signal R_{D} is provided to a Right-to-left (RL) filter 203 and to a right-to-right (RR) filter 204 wherein each filter is based on at least one of absolute time/distance difference and the interaural level difference of the right decorrelated audio signal R_{D}. Lastly, the decorrelated center audio signal C_{D} is provided to a center-to-left (CL) filter 206 and to a center-to-right (CR) filter 206 wherein each filter is based on at least one of absolute time difference and the interaural level difference of the decorrelated center audio signal C_{D}. The signal contributions at each respective ear position are combined with a respective left and right mixer 211, 212 which combines the signal contributions to form the output binaural audio signals L_{B}, R_{B}.

In some implementations, a time domain representation of each filter is

$$y [ n ] = \frac{{b}_{0}}{{a}_{0}} x [ n - ATD ] + \frac{{b}_{1}}{{a}_{0}} x [ n - ATD - 1 ] + \frac{{a}_{1}}{{a}_{0}} y [ n - 1 ] \qquad ( 12 )$$

where y is the output signal which has been filtered, x is the input signal, n denotes a sample or (potentially at least partially overlapping) time segment of the input audio signal, ATD is the absolute interaural time difference (expressed in samples/time segments or in units of time) and the parameters a₀, a₁, b₀, b₁ are based on the absolute interaural time difference and/or whether or not the present decorrelated audio signal and ear position defines an ipsilateral or contralateral acoustic channel (indicated e.g. by the second include angle β in the above). While equation 12 defines a time domain filter which is employed in each filter 201, 202, 203, 204, 205, 206 it is understood that each filter will be associated with an individual ATD value and different a₀, a₁, b₀, and b₁ parameters.

The time domain filter from equation 12 and the parameters a₀, a₁, b₀, and b₁ are described e.g. in connection equation (3) and (4) in “A Structural Model for Binaural Sound Synthesis”, C. Phillip Brown and Richard O. Duda, IEEE Transactions on Speech and Audio Processing, Vol. 6, No. 5, September 1998. It is understood that the direction of incidence of each decorrelated audio signal for each ear position will influence the a₀, a₁, b₀, and b₁ parameters to adjust the frequency response of the FIR-filter in equation 12. Moreover, it is noted in general that the gain for low frequencies will be zero (or at least close to zero) while the gain for high frequencies will be adjusted to a greater extent as the higher frequencies are more sensitive to the orientation of the ear positions with respect to the direction of incidence for the head-related transfer model.

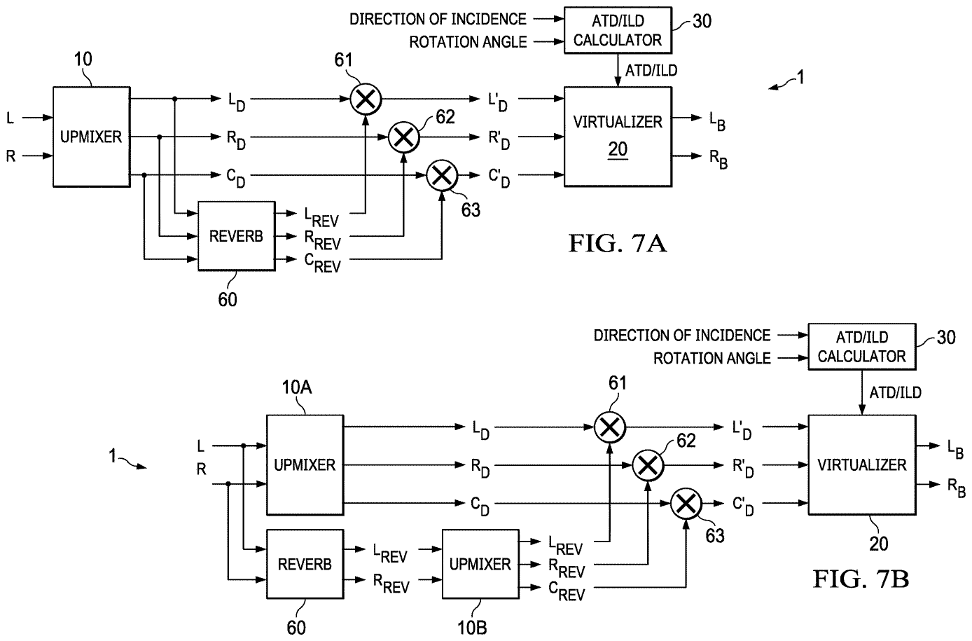

FIG. 7a illustrates an audio processing system 1 with an optional reverberation unit 60. The reverberation unit 60 is provided with the decorrelated left, right and center audio signals L_{D}, R_{D}, C_{D}, performs reverberation processing and outputs a reverberation adjusted decorrelated left, right and center audio signals L_{Rev}, R_{Rev}, C_{Rev}. The reverberation processing may comprise any suitable form of reverberation processing and, typically, reverberation processing is frequency dependent (e.g. performed for individual frequency bands) and based on e.g. a predetermined reverberation (decay) time and decay rate for each frequency band.

The reverberation adjusted decorrelated left, right and center audio signals L_{Rev}, R_{Rev}, C_{Rev} are combined with the left, right and center decorrelated audio signals L_{D}, R_{D}, C_{D} with a respective mixer 61, 62, 63 which results in a corresponding left, right and center decorrelated audio signal with reverberation L′_{D}, R′_{D}, C′_{D} which is provided to the virtualizer unit 20. The mixing ratio of the reverberation signals may be adjusted to obtain a suitable reverberation amount in the output audio signals L_{B}, R_{B}.

Additionally, further processing units (not shown) may be added to the audio processing system 1. For instance, an equalizer may be added between the upmixer 10 and the virtualizer unit 20 to equalize the decorrelated audio signals before these signals are provided to the virtualizer unit 20.

While the audio processing system 1 in FIG. 7a implements a reverberation unit 60 to provide output binaural audio signals Lb, Rb enhanced with reverberation effects the computation of the reverberation adjusted decorrelated left, right and center audio signals L_{Rev}, R_{Rev}, C_{Rev} may be computationally demanding. To this end, an alternative audio processing system with reverberation processing is illustrated in FIG. 7b.

In the implementation in FIG. 7b the input audio signals L, R (and not the decorrelated audio signals) are provided to the reverberation unit 60 wherein the reverberation unit 60 outputs reverberation adjusted left and right audio signals L_{Rev}, R_{Rev}. The reverberation adjusted left and right audio signals L_{Rev}, R_{Rev} are provided to an upmixer unit 10b which performs upmixing of the reverberation adjusted left and right audio signals L_{Rev}, R_{Rev} to form an upmixed representation of the reverberation adjusted audio signals. The upmixed representation comprises a decorrelated reverberation adjusted left, right and center audio signal L_{Rev}, R_{Rev}, C_{Rev} which are combined with the decorrelated audio signals L_{D}, R_{D}, C_{D} using mixers 61, 62, 63. The mixing results in a corresponding left, right and center decorrelated audio signal with reverberation L′D, R′D, C′D which is provided to the virtualizer unit 20.

The upmixer 10b, which performs the upmixing of the reverberation audio signals L_{Rev}, R_{Rev}, operates in a manner analogous to the upmixer 10a operating on the non-reverberation audio signals L, R. For instance, the upmixers 10, 10a, 10b in FIG. 7a and FIG. 7b may be equivalent to the upmixer described in connection to FIG. 1 in the above.

An effect of upmixing the reverberation audio signals L_{Rev}, R_{Rev} (as shown in FIG. 7b) as opposed to extracting a reverberation audio signal for each of the already upmixed audio signals (as shown in FIG. 7a) is that the former implementation is more computationally efficient. The reverberation processing performed by the reverberation unit 60 is computationally intensive and the efficiency of the audio processing system 1 is thus facilitated by first extracting the reverberation audio signals from the lower number of input audio signals L, R and then performing upmixing of the reverberation audio signals to the higher number of decorrelated audio signals.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention. For example, the stereo separation angle θ may be adjusted arbitrarily by e.g. the user selecting a desired stereo separation angle θ or it is envisaged that the input audio signal pair is associated with metadata indicating, a potentially time varying, separation angle to be used. For instance, the input audio signal pair may be associated with video content (such as a videogame or Virtual Reality application) and the separation angle θ is adjusted in tandem with the video content.

1. A method for generating a pair of binaural audio signals, the method comprising:
obtaining an audio presentation, the audio presentation comprising a pair of input audio signals;
performing upmixing of the input audio signal pair to generate three decorrelated audio signals, each decorrelated audio signal having a direction of incidence on a listening position;
obtaining a head-related transfer model positioned at the listening position, the head-related transfer model indicating a left ear position and a right ear position;
obtaining head rotation information-indicating the rotational orientation of a user's head with respect to the direction of incidence of the decorrelated audio signals;
for each of said three decorrelated audio signals, determining a pair of interaural difference values based on the direction of incidence of the three decorrelated audio signals, the head-related transfer model and the head rotation information; and
generating a binaural audio signal pair based on the three decorrelated audio signals and the interaural difference values for each of said three decorrelated audio signals.

2. The method according to claim 1, further comprising assigning, for each of the decorrelated audio signals, one ear position of the head-related transfer model as an ipsilateral or contralateral ear position and assigning the other one of said left and right ear position as the other one of the ipsilateral or contralateral ear position, based on the head rotation information and the direction of incidence of the decorrelated audio signal;
wherein determining a pair of interaural difference values comprises:
computing a first interaural difference value using a first function for the ipsilateral ear position; and
computing a second interaural difference value using a second function for the contralateral ear position.

3. The method according to claim 2, further comprising determining, for each ear position, an include angle, the include angle being the angle between the rotation of each ear position and the incidence direction associated with the decorrelated audio signal;
comparing the include angle of one ear position with a predetermined threshold;
if the include angle is below said predetermined threshold, assigning the ear position as the ipsilateral ear position;
else, assigning the ear as the contralateral ear position.

4. The method according to claim 1,
wherein the head-related transfer model comprises a head model shape with a center position and wherein the method further comprises:
determining, for each decorrelated audio signal an ipsilateral distance and a contralateral distance, said ipsilateral and contralateral distance being based on the shortest distance between an impact point and a respective ipsilateral and contralateral plane, the ipsilateral plane being normal to the direction of incidence of the decorrelated audio signal and intersecting the ipsilateral ear position and the contralateral plane being normal to the direction of incidence of the decorrelated audio signal and intersecting the center position, wherein the impact point is defined as the point first reached by a plane wave travelling against the head model shape along the direction of incidence,
wherein the contralateral distance is further based on a distance along the head shape and between the contralateral plane and the contralateral ear position, and
wherein the pair of interaural difference values is based on the ipsilateral distance and the contralateral distance.

5. The method according to claim 4, wherein the head model shape is a spherical shape with the left and right ear position being opposite points on said spherical shape.

6. The method according to claim 1, wherein the audio presentation is a stereo presentation or a binaural presentation.

7. The method according to claim 1, wherein the direction of incidence of the three decorrelated audio signals and the listening position are located in a same horizontal plane.

8. The method according to claim 1, further comprising
calculating a reverb signal for at least one of the three decorrelated audio signals; and
adding reverb to the binaural audio signal pair by combining the at least one reverb signal with at least one decorrelated audio signal.

9. The method according to claim 1, wherein the pair of interaural difference values is at least one of interaural time difference values and interaural level difference values.

10. The method according to claim 1, wherein generating a binaural audio signal pair comprises:
calculating a left filter and right filter for each decorrelated audio signal based on the pair of interaural difference values; and
processing each decorrelated audio signal with said left and right filters to form a left and right output audio signal for each decorrelated audio signal;
combining each left output audio signal into a left binaural audio signal; and combining each right output audio signal into a right binaural audio signal.

11. The method according to claim 1, wherein the three decorrelated audio signals comprises a decorrelated left audio signal, a decorrelated right audio signal, and a decorrelated center audio signal.

12. The method according to claim 11, wherein:
a left incidence direction is associated with the decorrelated left audio signal,
a right incidence direction is associated with the decorrelated right audio signal,
a center incidence direction is associated with the decorrelated center audio signal,
wherein the angle between left and center incidence direction is equal to a separation angle and wherein the angle of intersection between the right and center incidence direction is equal to the same separation angle.

13. The method according to claim 1, further comprising:
obtaining a second direction of incidence for each decorrelated audio signal, the second direction of incidence being different from the direction of incidence for at least one of the decorrelated audio signals;
for each of said three decorrelated audio signals, determining a pair of second interaural difference values based on the second direction of incidence for each decorrelated audio signal, the head rotation information and the head-related transfer model; and
generating a binaural audio signal pair based on the three decorrelated audio signals and the pair of second interaural difference values each of said three decorrelated audio signals.

14. An audio processing system for generating a pair of binaural audio signals, the system comprising:
an upmixer unit, configured to obtain an audio presentation, the audio presentation comprising a pair of input audio signals, and perform upmixing of the input audio signal pair to generate three decorrelated audio signals, each decorrelated audio signal having a direction of incidence on a listening position,
an interaural difference calculator unit, configured to obtain a head-related transfer model positioned at the listening position, the head-related transfer model indicating a left ear position and a right ear position, obtain head rotation information indicating the rotational orientation of a user's head with respect to the direction of incidence of the decorrelated audio signals and, for each of said three decorrelated audio signals, determine a pair of interaural difference values based on the direction of incidence of the three decorrelated audio signals, the head-related transfer model and the head rotation information, and
a virtualizer unit, configured to generate a binaural audio signal pair based on the three decorrelated audio signals and the interaural difference values for each of said three decorrelated audio signals.

15. A computer program product comprising instructions which, when the program is executed by a computer, cause the computer to carry out the steps of the method of claim 1.
